(19) United States
(12) Patent Application Publication
(10) Pub. No.: US 2015/0023610 A1
(43) Pub. Date: Jan. 22, 2015

(54) ENCODING METHOD AND SYSTEM USING BLOCK-BASED QUANTIZATION LEVEL THEREOF

(71) Applicant: QURAM CO., LTD., Suwon-si (KR)

(72) Inventor: Young Cheul WEE, Suwon-si (KR)

(21) Appl. No.: 14/331,496

(22) Filed: Jul. 15, 2014

(30) Foreign Application Priority Data
Jul. 16, 2013 (KR) 10-2013-0083653

(51) Int. Cl. H04N 19/91; H04N 19/192; H04N 19/176; H04N 19/124

(52) U.S. Cl. CPC H04N 19/00987; H04N 19/0009; H04N 19/00357; H04N 19/00278
USPC 382/251

(57) ABSTRACT

An encoding method and system using block-based quantization levels. In the encoding method, the encoding system calculates a feature value according to an image characteristic corresponding to a subject block to be quantized, the subject block being included in image information to be compressed, determines a quantization level of the subject block based on the calculated feature value of the subject block, quantizes the subject block with the determined quantization level, and determines a quantization level of at least one block from among blocks included in the image information to be compressed. The quantization level of the at least one block is different from the quantization level of the subject block.

### CROSS REFERENCE TO RELATED APPLICATION

The present application claims priority from Korean Patent Application Number 10-2013-0083653 filed on Jul. 16, 2013, the entire contents of which are incorporated herein for all purposes by this reference.

### BACKGROUND OF THE INVENTION

1. Field of the Invention

The present invention relates to an encoding method and system using block-based quantization levels, and more particularly, to an encoding method and system which can quantize blocks at different levels in consideration of the image characteristics of the blocks in an encoding method of encoding at least one block from among blocks included in image information to be compressed after quantization and lossy compression. More particularly, the present invention relates to a method and system capable of analyzing the characteristic of each block and determining an allowable loss range of each block where similar image quality can be retained before compression (e.g. quantization).

2. Description of Related Art

The principle of the present invention can be used for compressing various types of image information (e.g. a raw image in the case of image compression such as joint photographic experts group (JPEG) or a specific frame in the case of encoding of moving images) when performing quantization for the purpose of lossy compression.

The principle of the present invention can be used in a method of encoding moving images or a method of encoding images.

Various method of compressing image information are well known in the art.

FIG. 1 is a block diagram schematically illustrating a method of compressing image information of the related art.

Referring to FIG. 1, image information (e.g. a specific frame in the case of encoding moving images) including blocks (e.g. H.264 standard macro blocks or sub-macro blocks) can be performed on a block-by-block basis.

An encoding system (e.g. an H.264 encoder) performs lossy compression by transforming pixel data in the block of a frame that is to be compressed into frequency-range data by discrete cosine transform (DCT) at S10 and then performs quantization on the transformed data with a predetermined quantization level (e.g. H.264 quantization parameter (QP)) at S11. Afterwards, encoding is performed on the lossy-compressed data in a specific manner at S12. In this manner, compressed data of the image information can generated.

Here, the compression ratio of the image information predominantly depends on the level with which quantization is performed. The bit rate of a bit stream outputted from the encoding system is also predominantly determined by the quantization level.

In the meantime, a moving image encoding technology (e.g. H.264 standard) allows the quantization level to be adjusted on a block-by-block basis. In this manner, the adjustment of the quantization level has been used in order to perform efficient bit control within a limited bandwidth. This technology was disclosed in, for example, Korean Patent No. 10-1060495 (titled “ENCODING DEVICE AND METHOD AND MULTIMEDIA APPARATUS INCLUDING THE ENCODING DEVICE”) and Korean Patent No. 10-1185146 (titled “EFFICIENT CONTROL TECHNOLOGIES FOR VIDEO ENCODING”).

However, according to this related-art technology, when bit rate control is not required, various blocks having different image characteristics are quantized with a uniform quantization level. Therefore, there is a problem in that some blocks that can be compressed at a high compression ratio are compressed at a lower compression ratio. In addition, the quantization level is adjusted for bit rate control, a block may be quantized on a scale irrelevant to the image characteristics of that block, which is problematic.

There was disclosed a method of dynamically adjusting image information or a block-based quantization level (encoding quantization parameter) based on the similarities of images in order to encode moving images. An example of this method was known from United States Patent Application Publication No. US2012/0201475 A1 titled “METHOD AND SYSTEM FOR PROCESSING AN IMAGE” (hereinafter referred to as “Patent Document 3,” assigned to I.C.V.T. Ltd. This patent application publication employs a method of determining the encoding quality parameter based on the similarity (i.e. the presence of a visual degradation in image quality) between an uncompressed image and a compressed image. This method will be described in brief with reference to FIG. 2.

Referring to FIG. 2 (and FIG. 1 in Patent Document 3), this method includes step S20 of receiving a compressed JPEG image and step S21 of generating a raw image by decoding the received compressed image. The method also includes step S22 of re-encoding the raw image using an encoder (e.g. H.264) and then step S23 of generating a temporary raw image from the re-encoded image by format conversion.

At step S24, it is judged whether or not there is a similarity between the temporary raw image and the raw image by comparing the temporary raw image with the raw image. If there is the similarity (that is, there is no visual degradation in image quality), step S25 of changing the predetermined quantization level(or encoding quality parameter) and step S22 of re-encoding the raw image are iterated.

Although the method according to Patent Document 3 determines the encoding quality parameter in consideration of image characteristics, a similarity between before and after the compression is checked while compression (quantization step) is being performed. Afterwards, an iterative compression process based on the result of the checking is performed. This compression method performs quantization on a raw image without consideration of whether the raw image is a complicated image that has relatively little loss in visual image quality when there is significant loss or a simple image that has relatively little loss in visual image quality. In addition, compression speed is slow since the determination on whether or not to perform the compression again or stop the compression is iterated after the compression is performed once. Furthermore, this method fails to ensure that the final compression result is the optimum compression ratio, which is problematic. This is because the result of the previous quantization step becomes the final compression result, if there is no similarity (there is a visual degradation in image quality, i.e. an artifact occurs) after the final quantization step is performed. This accordingly fails to ensure that the result of the previous quantization step is compressed at the optimum compression ratio.

A principle intended to overcome these problem of Patent Document 4 was disclosed in Korean Patent Application Publication No. 10-2012-0091873, titled “ADAPTIVE IMAGE COMPRESSION SYSTEM AND METHOD,” which was assigned to the assigned of this application (hereinafter referred to as the “earlier application”). The principle and the entire contents disclosed in the specification of the earlier application are incorporated herein for all purposes by this reference and shall be regarded as being included in the description of this application.

Unlike image compression methods known in the art, the principle of the earlier application can perform compression in a non-iterative manner by determining a quantization level or scale that guarantees visual image quality depending on the characteristics of the image. In other words, this method can improve the compression ratio within the range of similar image quality by determining the allowable loss range where similar image quality is maintained by analyzing the characteristics of the image, generating an adaptive quantization table corresponding to the determined quantization table that is to be used in compression, and then performing compression based on the adaptive quantization table.

However, according to the principle of the earlier application, all blocks are quantized using one quantization table (the quantization table of the earlier application) for each piece of image information to be compressed. In this case, some blocks included in the image information to be compressed are compressed on the same quantization scale although they can be quantized on a greater quantization scale with no problems.

Therefore, there is required a method capable of adaptively determining the quantization levels of blocks included in image information to be compressed on a block-by-block basis by considering the characteristics of each block and performing compression (quantization) based on the determined quantization levels. In this case, it is also required to complete the compression (quantization) in a single process based on the quantization level that can be predetermined based on the characteristics of each block instead of determining the final quantization level by iteratively compressing the blocks on a block-by-block basis.

The information disclosed in the Background of the Invention section is provided only for better understanding of the background of the invention and should not be taken as an acknowledgment or any form of suggestion that this information forms a prior art that would already be known to a person skilled in the art.

### RELATED ART DOCUMENT

Patent Document 1: Korean Patent No. 10-1060495

Patent Document 2: Korean Patent No. 10-1185146

Patent Document 3: United States Patent Application Publication No. US2012/0201475 A1

Patent Document 4: Korean Patent Application Publication No. 10-2012-0091873

### BRIEF SUMMARY OF THE INVENTION

Various aspects of the present invention provide a method and system which can quantize a plurality of blocks included in image information to be compressed at different quantization levels while determining the quantization levels according to the characteristics of the blocks on a block-by-block basis.

Various aspects of the present invention also provide a method and system which can perform compression at one time by judging the characteristic of each block and determining in advance a quantization level suitable to a corresponding block instead of determining the block-based quantization level by iteratively performing quantization, thereby significantly improving the compression speed.

Various aspects of the present invention also provide a method and system which determine the quantization level of a subject block by considering not only the characteristic of the subject block but also the characteristics of surrounding blocks in order to prevent a visual degradation (artifact) that would otherwise occur at the block boundaries of the blocks which have different quantization levels.

In an aspect of the present invention, provided is an encoding method that includes the following steps of:

calculating, at an encoding system, a feature value according to an image characteristic corresponding to a subject block to be quantized, the subject block being included in image information to be compressed; determining, at the encoding system, a quantization level of the subject block based on the calculated feature value of the subject block; quantizing, at the encoding system, the subject block with the determined quantization level; and determining, at the encoding system, a quantization level of at least one block from among blocks included in the image information to be compressed, the quantization level of the at least one block being different from the quantization level of the subject block.

According to an exemplary embodiment of the invention, the encoding method may further include the step of checking, at the encoding system, a feature value corresponding to each of at least one surrounding block of the subject block. The step of determining the quantization level of the subject block based on the calculated feature value of the subject block includes determining, at the encoding system, the quantization level of the subject block further based on the checked feature value corresponding to each of the at least one surrounding block.

The step of determining the quantization level of the subject block further based on the checked feature value corresponding to each of the at least one surrounding block may include determining the quantization level of the subject block based on a value determined by the following formula:

WR×VR+ΣWi×Vi,

where WR indicates a weight value of the subject block, VR indicates the feature value of the subject block, i indicates an index of the surrounding block, Wi indicates a weight value of the surrounding block i, and Vi indicates the feature value of the surrounding block i.

The step of calculating the feature value according to the image characteristic corresponding to the subject block may include calculating, at the encoding system, an average of differential values of pixels included in the subject block as the feature value, each of the differential values being an average of differences, each of differences is difference of a pixel value of a specific pixel and pixel values of pixels surrounding the specific pixel.

The image information to be compressed may be a raw image that is to be lossy compressed, a frame that is to be included in a moving image for encoding of the moving image, or a macro block included in the frame.

In another aspect of the present invention, provided is an encoding method that includes the following steps of: quantizing, at an encoding system, a first block included in image information to be compressed; and quantizing, at the encoding system, a second block included in the image information to be compressed. The step of quantizing the first block included in image information to be compressed includes, at the encoding system, calculating a first feature value according to an image characteristic corresponding to the first block and quantizing the first block with a first quantization level that is determined based on the calculated first feature value. The step of quantizing the second block included in the image information to be compressed includes, at the encoding system, quantizing the second block according to a second quantization level that is determined based on a second feature value according to an image characteristic corresponding to the second block and at least one feature value each corresponding to a corresponding block of at least one surrounding block of the second block.

In another aspect of the present invention, provided is an encoding method that includes the following steps of: calculating, at an encoding system, a feature values according to an image characteristic corresponding to a blocks to be quantized, the blocks being included in image information to be compressed; determining, at the encoding system, a quantization level of the image information based on the calculated feature values of the blocks; and

quantizing, at the encoding system, the image information with the determined quantization level; wherein determining the quantization level of the image information based on the calculated feature values of the blocks comprises determining the quantization level based on average of the feature values of each of the blocks.

In a further aspect of the present invention, provided is a computer readable record medium which stores therein a program for carrying out the above-mentioned encoding method using block-based quantization levels.

In further another aspect of the present invention, provided is an encoding system that includes: a feature extraction module which calculates a feature value according to an image characteristic corresponding to a subject block to be quantized, the subject block being included in image information to be compressed; a determination module which determines a quantization level of the subject block based on the feature value of the subject block calculated by the feature extraction module; and a quantization module which quantizes the subject block with the quantization level determined by the determination module. The determination module determines a quantization level of at least one block from among blocks included in the image information to be compressed, the quantization level of the at least one block being different from the quantization level of the subject block.

The determination module may further check a feature value corresponding to each of at least one surrounding block of the subject block calculated by the feature extraction module and determines the quantization level of the subject block further based on the checked feature value corresponding to each of the at least one surrounding block of the subject block.

The determination module may determine the quantization level of the subject block further based on a value determined by the following formula:

WR×VR+ΣWi×Vi,

where WR indicates a weight value of the subject block, VR indicates the feature value of the subject block, i indicates an index of the surrounding block, Wi indicates a weight value of the surrounding block i, and Vi indicates the feature value of the surrounding block i.

The feature extraction module may calculate an average of differential values of pixels included in the subject block as the feature value, each of the differential values being an average of differences, each of differences is difference of a pixel value of a specific pixel and pixel values of pixels surrounding the specific pixel.

In yet another aspect of the present invention, provided is an encoding system that includes: a feature extraction module which calculates a feature value according to an image characteristic of each of at least one block from among blocks included in image information to be compressed; and a determination module which determines quantization levels of first and second blocks included in the image information to be compressed based on the feature value of each of the at least one block calculated by the feature extraction module. The determination module determines a first quantization level determined based on a first feature value corresponding to the first block, the first feature value being calculated by the feature extraction module, in order to quantize the first block. The determination module determines a second quantization level based on a second feature value corresponding to the second block, the second feature value being calculated by the feature extraction module, and at least one feature value each corresponding to a corresponding block of the at least one surrounding block of the second block in order to quantize the second block.

In yet another aspect of the present invention, provided is an encoding system that includes: a feature extraction module which calculates a feature values according to an image characteristic corresponding to a blocks to be quantized, the blocks being included in image information to be compressed; and a determination module which determines a quantization level of the image information based on the calculated feature values of the blocks, wherein the determination module determines the quantization level of based on average of the feature values of each of the blocks.

According to the principle of the invention, when blocks included in image information to be compressed are quantized, the quantization levels of the blocks can be determined on a block-by-block basis by considering the characteristic of each block to be quantized. It is therefore possible to provide a compressed image within the range of similar image quality while providing a higher compression ratio than when a uniform quantization level is applied to each block.

In addition, when the quantization levels of the blocks included in the image information to be compressed are determined, it is possible to complete compression (quantization) in a single quantization process only through simple calculation according to the characteristics of the blocks instead of checking the image quality after iterative compression. Accordingly, the compression speed can be significantly improved.

Furthermore, the quantization level of a subject block is determined by considering not only the image characteristic of the subject block but also the image characteristics of the surrounding blocks. This can consequently prevent a visual degradation (artifact) in image quality that would otherwise occur at the block boundaries of the blocks which have different quantization levels.

The methods and apparatuses of the present invention have other features and advantages which will be apparent from, or are set forth in greater detail in the accompanying drawings, which are incorporated herein, and in the following Detailed Description of the Invention, which together serve to explain certain principles of the present invention.

### BRIEF DESCRIPTION OF THE DRAWINGS

Brief descriptions of individual figures are given for better understanding of the drawings which are referred to in the Detailed Description of the Invention section.

FIG. 1 is a block diagram schematically illustrating a method of compressing image information of the related art;

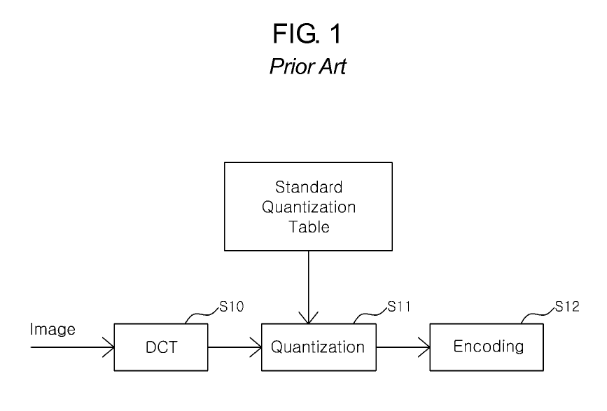

FIG. 2 is a schematic flowchart illustrating a method of determining a quantization level by iterative compression of the related art;

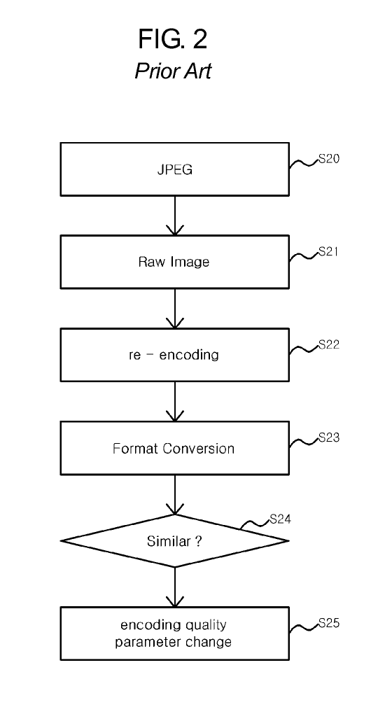

FIG. 3 is a schematic block diagram illustrating an encoding system using block-based quantization levels according to an exemplary embodiment of the invention;

FIG. 4 is a view illustrating a case in which an encoding method using block-based quantization levels according to an exemplary embodiment of the invention is applied to moving image frames;

FIG. 5 is a schematic flowchart illustrating the encoding method using block-based quantization levels according to an exemplary embodiment of the invention; and

FIG. 6 is a view illustrating a method of judging an image feature value of each block in the encoding method using block-based quantization levels according to an exemplary embodiment of the invention.

### DETAILED DESCRIPTION OF THE INVENTION

The present invention, advantages associated with the operation of the present invention and objects that are realized by the practice of the present invention will be apparent from the accompanying drawings which illustrate exemplary embodiments of the present invention and the detailed description of the present invention which are illustrated in the drawings.

Throughout the specification, it will be understood that, when an element is referred to as “transmitting” data to another element, the element not only can directly transmit the data to another element but also indirectly transmit the data to another element via at least one intervening element.

In contrast, when an element is referred to as “directly transmitting” data to another element, the element can transmit the data to another element without an intervening element.

The present invention will now be described more fully hereinafter with reference to the accompanying drawings, in which exemplary embodiments thereof are shown. Reference should be made to the drawings, in which the same reference numerals are used throughout the different drawings to designate the same or similar components.

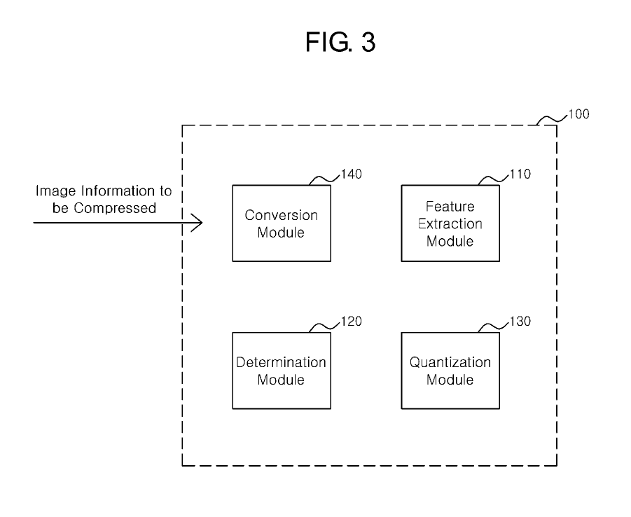

FIG. 3 is a schematic block diagram illustrating the configuration of an encoding system using block-based quantization levels according to an exemplary embodiment of the invention.

Referring to FIG. 3, the encoding system 100 using block-based quantization levels according to this embodiment (hereinafter referred to as the “encoding system” 100) includes a feature extraction module 110, a determination module 120 and a quantization module 130. The encoding system 100 can further include a conversion module 140 which performs discrete cosine transform.

Although not shown in FIG. 3, the encoding system 100 can further include, for example, a type converter and an encoding module, which are apparent to a person skilled in the art.

Herein, the term “module” may indicate a functional and/or structural combination of hardware that can realize the principle of the present invention and software that can drive the hardware. For example, the “module” may mean a logical unit of codes and hardware resources that execute the codes. It should not be understood to a person skilled in the art to which the present invention relates that the codes are physically connected or that the hardware resources make one type of hardware.

In some implementations, the encoding system 100 can be distributed to a plurality of physical devices instead of being located in a single physical entity. When individual components of the encoding system 100 are implemented as independent physical devices as required, these physical devices can be systematically combined by means of wired/wireless networks in order to realize the encoding system 100 according to the principle of the present invention.

The encoding system 100 can be disposed in a variety of data processing devices (e.g., a computer or a mobile phone) in which an image encoder or a moving image encoder configured to compress image information is provided in order to embody the principle of the present invention. In particular, although the encoding system 100 is described in relation to the configuration which performs quantization when compressing image information in order to clarify the features of the principle of the present invention, it is apparent to a person skilled in the art that the encoding system 100 can indicate a variety of data processing devices which includes the configuration defined herein.

The encoding system 100 can obtain image information that is to be compressed by receiving that image information or by performing a process (e.g., sampling or type conversion) on image information or a moving image that has been received. The encoding system 100 can obtain the image information to be compressed by performing decoding as required. For example, the image information to be compressed can be obtained based on raw image information (e.g. RGB, YUV, BMP, PNG or TIFF) that is obtained after an image inputted into the encoding system 100 is decoded using an image compression format (e.g., joint photographic experts group (JPEG)) or a moving image compression format (e.g., H.264 or MP4).

Accordingly, the image information to be compressed can be raw image information that has not been quantized (e.g., a YUV format image). In an example, the image information to be compressed can be a picture, a frame or a macro block included in the frame which can be specified during moving image encoding.

Then, the encoding system 100 can obtain the image information to be compressed and then perform quantization on the respective blocks of the image information. For this, the conversion module 140 of the encoding system 100 can perform DCT conversion on the entire image information to be compressed or each of the blocks of the image information.

Consequently, DCT-converted data that is included in the image information to be compressed and corresponds to a subject block that is subjected to quantization can be quantized with a quantization level by the quantization module 130. Here, the quantization level of the subject block can be determined by the determination module 120. The determination of the quantization level may indicate that a quantization parameter (QP) is determined when the encoding system 100 is based on the H.264 standard. In addition, when the encoding system 100 is a component of a moving image encoder, the subject block can be a macro block or a sub-macro block that needs to be quantized.

In some implementations, the encoding system 100 may not be based on the H.264 standard. In this case, it can be understood that a quantization table with which the subject block is quantized is determined. In any cases, the determination of the quantization level may indicate a process of determining how much level with which a DCT coefficient of the subject block is to be quantized. When the quantization level is determined, the quantization module 130 can perform quantization using the predefined quantization table. In some implementations, the quantization table can be generated in real time depending on the determined quantization level.

In this case, the encoding system 100 according to the principle of the invention can quantize the blocks included in the image information to be compressed at different quantization levels. That is, the determination module 120 can determine different quantization levels for at least two blocks from among the blocks included in the image information to be compressed. It is of course possible to determine that all blocks are quantized at different quantization levels.

Therefore, when the encoding system 100 according to the principle of the invention is applied to an image encoder, the image encoder can be used as an encoder to which the JPEG standard is not applied since the JPEG standard sets the same quantization level to all of a plurality of blocks included in one image (since one quantization table is used).

When the encoding system 100 according to the principle of the invention is applied to a moving image encoder, the moving image encoder can be used as an encoder which is based, for example, on the H.264 standard since the H.264 standard can set different quantization levels to blocks. However, according to the related-art technologies as described above, the quantization level was adjust for the entire image information or on a block-by-block basis in order to adjust the bit rate. Therefore, the quantization level was adjusted regardless of the characteristics of the entire image or the image characteristics of the blocks. In contrast, according to the principle of the invention as described below, the quantization level is adaptively adjusted depending on the image characteristic of each block (that is, depending on the image in which the quantization level can be raised or lowered), such that quantization is performed within the range where a visual similarity in image quality is ensured on a block-by-block basis.

In addition, according to Patent Document 3 as mentioned above, compression is performed in an iterative manner while the similarity in quality between the image before and after compression (quantization) is being compared. In contrast, according to the principle of the invention, block-based image characteristics are calculated in a predetermined manner, and quantization is performed once according to the calculated characteristics. Consequently, there are effects in that the compression is performed at a much faster speed and that a visual similarity in image quality can be provided.

In this manner, the method of determining the quantization level by the determination module 120 according to the principle of the invention uses a feature value according to the block-based image characteristic. The block-based image characteristic indicates a characteristic related to the level with which a corresponding block is compressed or quantized, and can be expressed by a block-based feature value.

The block-based feature value can be calculated by the feature extraction module 110.

The feature value calculated by the feature extraction module 110 can be a reference that indicates a quantization level with or below which no visual change in the image quality is caused by quantization. Therefore, the feature extraction module 110 can calculate the feature value, which can be the reference, by a predetermined method.

The feature extraction module 110 can judge the characteristic of at least one block from among the blocks included in the image information to be compressed that is obtained by the encoding system 100. Specifically, the feature extraction module 110 can judge the characteristic related to compression, such as complexity which indicates whether the block included in the image information to be compressed is a complicated image or a simple image, image quality, types (such as gradation, strong edge or texture). These block-based characteristics of the image must be considered since the encoding system 100 performs lossy compression. This is because the image corresponding to a subject block may be an image, the visible quality of which is significantly influenced when information is lost to a predetermined degree, or an image, the visible quality of which is significantly influenced when information is lost to a predetermined degree, depending on its characteristics.

Therefore, according to the principle of the invention, when the feature value of a block is judged by the feature extraction module 110, the quantization level which is to be applied to the block can be determined.

The method of calculating a feature value can be implemented as a variety of methods. In any case, the feature value can be defined as a value that acts as a reference with which the quantization level of a specific block is judged.

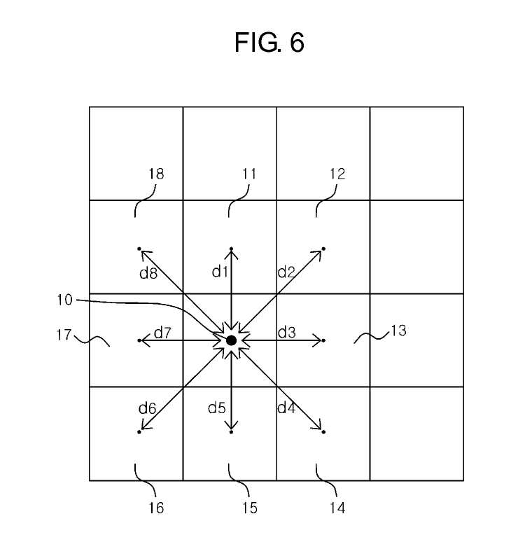

A method of calculating a feature value according to an exemplary embodiment of the invention is shown in FIG. 6.

FIG. 6 is a view illustrating the method of judging the image feature value of each block in the encoding method using block-based quantization levels according to an exemplary embodiment of the invention.

Referring to FIG. 3 and FIG. 6, image information to be compressed that has been obtained by the encoding system 100 can be inputted into the feature extraction module 110. The image information to be compressed can be, for example, a gray image, or a piece of data that has a luminance value of the image, and can be stored in a buffer. Then, the feature extraction module 110 can read the data from the buffer.

The feature extraction module 110 can calculate feature values that exhibit the image characteristics of blocks included in the image information on a block-by-block basis. Although these blocks can be 8-pixel array blocks, this is not intended to be limiting.

The feature value can be information that exhibits the feature of a partial image, i.e. an image corresponding to each block, of the image information to be compressed. The feature value can be related to the level with which each block can be compressed. Here, the feature value will be referred to as a block quality indicator (BQI).

As shown in FIG. 6, the BQI can be calculated as an average of differential values of pixels in the block. A higher average of the differential values may indicate that the complexity of a partial image corresponding to the block is higher or that there are many changes in luminance within the partial image. In addition, the higher average of the differential values or the higher BQI may indicate that a visual degradation in the image quality is relatively insignificant when the compression ratio is high.

The differential value of one pixel, for example, a pixel 10, in the block may indicate the average of the differences d1 to d7 between the value of the pixel 10 and the values of the surrounding pixels 11 to 17. When the differential value of one pixel in the block is determined in this manner, the differential values of the other pixels can be determined in the same manner. Then, the feature extraction module 110 can calculate the differential values of the entire pixels in the block, thereby calculating the BQI of the block.

When the feature value, or the BQI, of the block is calculated in this manner, the quantization level corresponding to the calculated BQI can be determined. The quantization level corresponding to the BQI can be determined by iterative experiments and predefined by the encoding system 100. For example, when the encoding system 100 is applied to a moving image encoder, information on a QP corresponding to the calculated BQI can be previously stored in the encoding system 100.

In some implementations, when the BQI of the corresponding block is calculated, the determination module 120 can generate a quantization table corresponding to the calculated BQI in a predetermined manner. For example, it is possible to generate a quantization table corresponding to the subject block by scaling the values of the elements of the predetermined quantization table using the BQI.

In any case, according to the principle of the invention, the quantization level can be determined depending on the block-based image characteristic (e.g., the feature value), and the quantization module 130 can quantize the subject block depending on the determined quantization level.

Therefore, when the image characteristics of the plurality of blocks in the image information to be compressed are different, the encoding system 100 can perform quantization with different quantization levels. In addition, as described with reference to FIG. 6, the feature value that can indicate the image characteristic of the subject block is defined in a predetermined manner, and when the defined feature value is calculated by the feature extraction module 110, the quantization level can be defined in one process. Thus, the quantization can be performed in a short time. Although the description herein was generally given with respect to an example of calculating the feature value that can express the complexity of the block, a person skilled in the art can easily make various modifications or other embodiments that can calculate the block-based characteristics related to the quantization levels.

In some other implementation, the principle of the invention can be applied to an encoder which can use only one quantization level to whole image information to be compressed (like JPEG standard). For this implementation, the determination module 120 can also determine quantization level for whole image information based on plurality of blocks included in the image information. That is, different from above mentioned (the determination module 120 determine quantization level of each of the blocks), the determination module 120 can determine one quantization level for the image information using the blocks' feature values. The blocks can be all blocks included in the image information or plural blocks selected by predetermined criteria from the all block. For instance, each of all blocks' feature values can be calculated by the feature extraction module 110. Then the determination module may determine the quantization level for the image information based on the calculated feature values. For instance, an average of the feature values can be used for determine the quantization level for the image information. In some implementation, the determination module 120 may calculate feature value of each block among the blocks, and calculate average of feature values of the blocks. Then the determination module 120 may determine the quantization level for the image information, i.e. single quantization level for the blocks, based on the average of feature values of the blocks. In other implementation, the determination module 120 may calculate an each element of quantization table for image information. The each element of quantization table for the image information may be calculated according to elements of quantization tables for the blocks. In this manner the quantization tables for the blocks are not actually used for quantizing process, they may be used only for calculate the quantization table for the image information. For instance, a first element of the quantization table for the image information can be calculated based on first elements of each quantization tables for the blocks. Of course the first element of the quantization table for the image information can be average of first elements of each quantization tables for the blocks, but it's not restricted to average.

Returning to FIG. 3, when the feature value of the subject block is calculated by the feature extraction module 110, the determination module 120 can determine the quantization level corresponding to the calculated feature value. Then, the quantization module 130 can perform quantization at the determined quantization level.

The data obtained as the result of the execution of the quantization can be encoded in a predetermined manner. An encoding module (not shown) for this purpose can of course be added to the encoding system 100. For example, when the encoding system 100 is included in an H.264 moving image encoder, the encoding module (not shown) can perform entropy encoding. When the encoding system 100 is included in a JPEG encoder, the encoding module can perform encoding in an encoding method defined by the JPEG standard. Various types of encoding are possible.

Consequently, according to the principle of the invention, it is possible to perform quantization by adaptively determining a block-based quantization level that is suitable to a corresponding block. Therefore, it is possible to improve compression efficiency to be higher than when a plurality of blocks included in image information is quantized at a uniform quantization level without a visual degradation in image quality.

In addition, when the blocks are quantized at different quantization levels, for example, according to the principle of the invention, there is a problem in that an artifact (e.g., a visual degradation in image quality) may occur in regions corresponding to block boundaries when the quantization levels of the adjacent blocks are different to a certain degree.

According to the principle of the invention, in order to overcome this problem, the encoding system 100 can perform quantization by considering not only the feature value of the subject block but also the feature value of at least one block from among the surrounding blocks of the subject block when determining the quantization level of the subject block. Therefore, the quantization level of the subject block is influenced by the feature value of the surrounding block, whereby a significant difference can be prevented from occurring between the quantization levels of the subject block and the surrounding block.

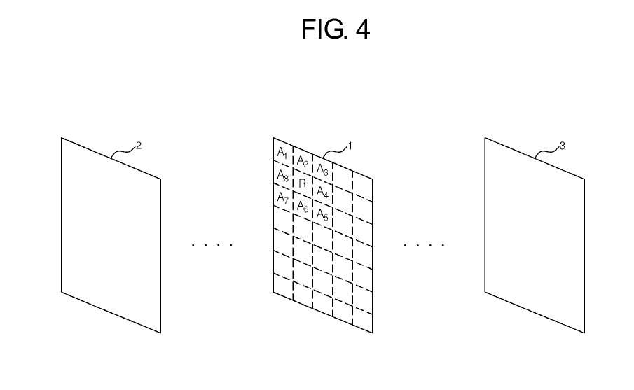

Such an example will be described with reference to FIG. 4.

FIG. 4 is a view illustrating a case in which an encoding method using block-based quantization levels according to an exemplary embodiment of the invention is applied to moving image frames.

FIG. 4 shows an example in which the encoding system 100 compresses a frame 1 which is determined during encoding of a moving image. In an example, when image information that is to be compressed by the encoding system 100, i.e. the frame 1, is an I frame (intra frame), the encoding system 100 can quantize all blocks in the I frame. When the image information to be compressed, i.e. the frame 1, is a P frame (predictive frame) or a B frame (bidirectional predictive frame), the encoding system 100 can select some blocks that require quantization and quantize only the selected blocks.

When a block R in the frame 1 shown in FIG. 4 is selected as a subject block that is to be quantized, the determination module 120 can determine the quantization level of the block R only based on the feature value of the block R that is calculated by the feature extraction module 110.

However, in order to prevent artifacts from occurring at the block boundaries when different quantization levels are applied to the blocks as described above, the determination module 120 determine the quantization level of the block R by further considering the feature value of at least one block of the blocks (e.g., A1 to A8) surrounding the block R. In this case, the number of the surrounding blocks, the feature values of which are referred to, may differ depending on the position of the block R in the image information to be compressed. In addition, the feature values of some of the surrounding blocks can be selectively referred to.

In some implementations, when the subject block is a first block, for example, a block A1, from among the blocks in the frame 1, the determination module 120 can determine the quantization level only based on the feature value of the first block. When the subject block is a second block, for example, the block R, the determination module 120 can determine the quantization level further based on the feature value of at least one surrounding block of the second block. When the quantization level of the block is determined only based on its feature value, the block can be a corner block which is relatively little influenced by the surrounding blocks in the image information to be compressed or a block which is selected according to a predetermined reference. In addition, the surrounding blocks of the specific block may not be quantized during the encoding of the moving image. In this case, it may be inappropriate that the quantization level of the specific block is influenced by the feature values of the surrounding blocks. Of course, the quantization levels of all of the blocks may be determined further based on the feature values of their surrounding blocks.

According to an embodiment, the determination module 120 can refer to the feature value of the block R and the feature value of at least one surrounding block, for example, from among blocks A1 to A8 in order to determine the quantization level of the block R. This case can be based on Formula 1 below:

W_{R}×V_{R}+ΣWᵢ×Vᵢ Formula 1

In Formula 1 above, W_{R} indicates the weight value of the subject block, V_{R} indicates the feature value of the subject block, i indicates the index of the surrounding block, Wᵢ indicates the weight value of the surrounding block i, and the Vᵢ indicates the feature value of the surrounding block i. Consequently, the quantization level of the block R is influenced by the feature values of the surrounding blocks, for example, blocks A1 to A8, and the quantization levels of the surrounding blocks (for example, blocks A1 to A8) of the block R are influenced by the feature value of the block R. It is therefore possible to prevent that the quantization levels of the adjacent blocks are determined to be significantly different from each other.

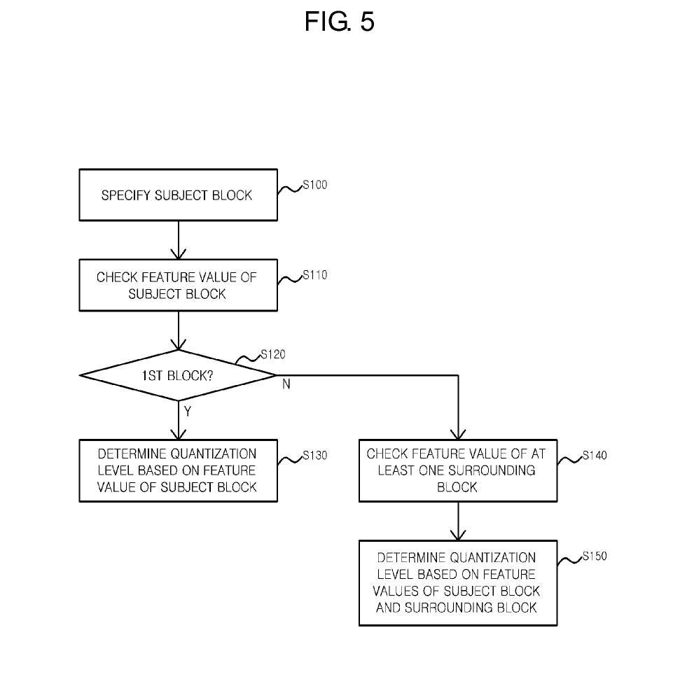

The above-mentioned encoding method can be schematically illustrated as in FIG. 5.

FIG. 5 is a schematic flowchart illustrating the encoding method using block-based quantization levels according to an exemplary embodiment of the invention.

Referring to FIG. 5, at step S100, the encoding system 100 can specify a subject block that is to be quantized from among blocks in image information to be compressed.

Afterwards, at step S110, the encoding system 100 can check the feature value of the subject block. The feature extraction module 110 of the encoding system 100 can store the feature values of at least some of the blocks in the image information to be compressed in a storage device by calculating the feature values in advance. Alternatively, the feature extraction module 110 can calculate the feature value of a corresponding block whenever quantization is performed on a block-by-block basis.

After that, at step S120, the encoding system 100 can judge whether or not the subject block is a first block. The first block can be defined as a block, the quantization level of which is determined only based on the feature value thereof. The encoding system 100 can select in advance or real time a block as the firs block.

Afterwards, if the subject block is the first block, at step S130, the encoding system can determine the quantization level based on the feature value of the subject block. If the subject block is a second block, the encoding system 100 further checks the feature value of at least one surrounding block of the subject block at step S140, and determine the quantization level further based on the checked feature value of the surrounding block (as in Formula 1) at step S150.

When the quantization level the subject block is determined further based on the feature value of the surrounding block (when the quantization level is determined based on the value obtained, for example, from Formula 1), the reference with which the quantization level (e.g., QP) is determined depending on the obtained value may, of course, be different from the reference with which the quantization level is determined depending on the value obtained from when only the feature value of the subject block is based on.

The embodiments of the encoding method and system using block-based quantization levels according to the present invention can be embodied as computer readable codes that are stored in a computer readable recording medium. The computer readable recording medium includes all sorts of record devices in which data that are readable by a computer system are stored. Examples of the computer readable recording medium include read only memory (ROM), random access memory (RAM), compact disc read only memory (CD-ROM), a magnetic tape, a hard disc, a floppy disc, an optical data storage device and the like. Further, the recording medium may be implemented in the form of a carrier wave (e.g. Internet transmission). In addition, the computer readable recording medium may be distributed to computer systems on the network, in which the computer readable codes are stored and executed in a decentralized fashion. In addition, functional programs, codes and code segments for embodying the present invention can be easily construed by programmers having ordinary skill in the art to which the present invention pertains.

While the present invention has been described with reference to the certain exemplary embodiments shown in the drawings, it will be understood by a person skilled in the art that various modifications and equivalent other embodiments may be made therefrom. Therefore, the true scope of the present invention shall be defined by the concept of the appended claims.

What is claimed is:

1. An encoding method comprising:
calculating, at an encoding system, a feature value according to an image characteristic corresponding to a subject block to be quantized, the subject block being included in image information to be compressed;
determining, at the encoding system, a quantization level of the subject block based on the calculated feature value of the subject block;
quantizing, at the encoding system, the subject block with the determined quantization level; and
determining, at the encoding system, a quantization level of at least one block from among blocks included in the image information to be compressed, the quantization level of the at least one block being different from the quantization level of the subject block.

2. The encoding method according to claim 1, further comprising checking, at the encoding system, a feature value corresponding to each of at least one surrounding block of the subject block,
wherein determining the quantization level of the subject block based on the calculated feature value of the subject block comprises determining, at the encoding system, the quantization level of the subject block further based on the checked feature value corresponding to each of the at least one surrounding block.

3. The encoding method according to claim 2, wherein determining the quantization level of the subject block further based on the checked feature value corresponding to each of the at least one surrounding block comprises determining the quantization level of the subject block based on a value determined by the following formula:
WR×VR+ΣWi×Vi,
where WR indicates a weight value of the subject block, VR indicates the feature value of the subject block, i indicates an index of the surrounding block, Wi indicates a weight value of the surrounding block i, and Vi indicates the feature value of the surrounding block i.

4. The encoding method according to claim 1, wherein calculating the feature value according to the image characteristic corresponding to the subject block comprises calculating, at the encoding system, an average of differential values of pixels included in the subject block as the feature value, each of the differential values being an average of differences, each of differences is difference of a pixel value of a specific pixel and pixel values of pixels surrounding the specific pixel.

5. The encoding method according to claim 1, wherein the image information to be compressed comprises a raw image that is to be lossy compressed, a frame that is to be included in a moving image for encoding of the moving image, or a macro block included in the frame.

6. An encoding method comprising:
quantizing, at an encoding system, a first block included in image information to be compressed; and
quantizing, at the encoding system, a second block included in the image information to be compressed, wherein
quantizing the first block included in image information to be compressed comprises, at the encoding system, calculating a first feature value according to an image characteristic corresponding to the first block and quantizing the first block with a first quantization level that is determined based on the calculated first feature value, and
quantizing the second block included in the image information to be compressed comprises, at the encoding system, quantizing the second block according to a second quantization level that is determined based on a second feature value according to an image characteristic corresponding to the second block and at least one feature value each corresponding to a corresponding block of at least one surrounding block of the second block.

7. An encoding method comprising:
calculating, at an encoding system, a feature values according to an image characteristic corresponding to a blocks to be quantized, the blocks being included in image information to be compressed;
determining, at the encoding system, a quantization level of the image information based on the calculated feature values of the blocks; and
quantizing, at the encoding system, the image information with the determined quantization level;
wherein determining the quantization level of the image information based on the calculated feature values of the blocks comprises determining the quantization level based on average of the feature values of each of the blocks.

8. A non-transitory computer readable record medium which stores therein a program for carrying out the method claimed in claim 1.

9. A non-transitory computer readable record medium which stores therein a program for carrying out the method claimed in claim 2.

10. A non-transitory computer readable record medium which stores therein a program for carrying out the method claimed in claim 3.

11. A non-transitory computer readable record medium which stores therein a program for carrying out the method claimed in claim 4.

12. A non-transitory computer readable record medium which stores therein a program for carrying out the method claimed in claim 5.

13. A non-transitory computer readable record medium which stores therein a program for carrying out the method claimed in claim 6.

14. An encoding system comprising:
a feature extraction module which calculates a feature value according to an image characteristic corresponding to a subject block to be quantized, the subject block being included in image information to be compressed;
a determination module which determines a quantization level of the subject block based on the feature value of the subject block calculated by the feature extraction module; and
a quantization module which quantizes the subject block with the quantization level determined by the determination module,
wherein the determination module determines a quantization level of at least one block from among blocks included in the image information to be compressed, the quantization level of the at least one block being different from the quantization level of the subject block.

15. The encoding system according to claim 13, wherein the determination module further checks a feature value corresponding to each of at least one surrounding block of the subject block calculated by the feature extraction module and determines the quantization level of the subject block further based on the checked feature value corresponding to each of the at least one surrounding block of the subject block.

16. The encoding system according to claim 14, wherein the determination module determines the quantization level of the subject block further based on a value determined by the following formula:
WR×VR+ΣWi×Vi,
where WR indicates a weight value of the subject block, VR indicates the feature value of the subject block, i indicates an index of the surrounding block, Wi indicates a weight value of the surrounding block i, and Vi indicates the feature value of the surrounding block i.

17. The encoding system according to claim 13, wherein the feature extraction module calculates an average of differential values of pixels included in the subject block as the feature value, each of the differential values being an average of differences, each of differences is difference of a pixel value of a specific pixel and pixel values of pixels surrounding the specific pixel.

18. An encoding system comprising:
a feature extraction module which calculates a feature value according to an image characteristic of each of at least one block from among blocks included in image information to be compressed; and
a determination module which determines quantization levels of first and second blocks included in the image information to be compressed based on the feature value of each of the at least one block calculated by the feature extraction module, wherein
the determination module determines a first quantization level based on a first feature value corresponding to the first block, the first feature value being calculated by the feature extraction module, in order to quantize the first block, and
the determination module determines a second quantization level based on a second feature value corresponding to the second block, the second feature value being calculated by the feature extraction module, and at least one feature value each corresponding to a corresponding block of the at least one surrounding block of the second block in order to quantize the second block.

19. An encoding system comprising:
a feature extraction module which calculates a feature values according to an image characteristic corresponding to a blocks to be quantized, the blocks being included in image information to be compressed; and
a determination module which determines a quantization level of the image information based on the calculated feature values of the blocks, wherein
the determination module determines the quantization level of based on average of the feature values of each of the blocks.
